(19) United States
(12) Patent Application Publication
(10) Pub. No.: US 2009/0080404 A1
(43) Pub. Date: Mar. 26, 2009

(54) Active profile selection

(75) Inventors: Antti Laurila, Helsinki (FI); Eva-Maria Leppanen, Lempaala (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/904,618

(22) Filed: Sep. 26, 2007

(51) Int. Cl. H04B 7/212

(52) U.S. Cl. 370/348

(57) ABSTRACT

In a network enabling a communication between different devices, a network element may receive an indication of an active profile for at least one device. The indication of the active profile may then be used as a criterion for an operation in the network element. Moreover, a device may use a selected active profile as a criterion for determining presence information content, the presence information content indicating the availability of a user of the device for a communication. The presence information may then be transmitted to the network.

### FIELD OF THE INVENTION

The invention relates to a usage profile that is selected to be an active profile of a device.

### BACKGROUND OF THE INVENTION

Various devices comprise a definition of different usage profiles, which specify settings for different use cases. In the case of a mobile phone, for example, “meeting” or “silent” profiles could have certain ringing tones configured as muted or set to a beep mode.

The usage profiles that are defined in a device may be completely predetermined. Alternatively or in addition, they may be predetermined but comprise default settings which can be changed by a user. Further alternatively or in addition, a user may be enabled to define own usage profiles.

Depending on a current situation, a user may select one of the defined usage profiles to be the active profile. The settings specified in the active profile are then used for device internal functionality.

### SUMMARY

For a first aspect of the invention, a method is described which comprises receiving at a network element of a network an indication of an active profile for at least one device, the network enabling a communication between different devices. The method further comprises using the indication of the active profile as a criterion for an operation in the network element.

For the first aspect, moreover, an apparatus is described which comprises a processing component. The processing component is configured to receive an indication of an active profile for at least one device. The processing component is further configured to use the indication of the active profile as a criterion for an operation in the apparatus. The apparatus belongs to a network enabling a communication between different devices.

For the first aspect, moreover a system is described which comprises the apparatus of the first aspect. In addition, the system comprises an apparatus belonging to the network and including a storage configured to store an indication of an active profile for at least one device and/or at least one device configured to provide an indication of an active profile for the at least one device to the network and/or at least one device configured to provide a definition of an operation.

For the first aspect, moreover a computer program product is described, in which a program code is stored in a computer readable medium. When executed by a processor, the program code realizes the method of the first aspect. The computer program product could be for example a separate memory device, or a memory that is to be integrated in an electronic device.

The invention is to be understood to cover such a computer program code also independently from a computer program product and a computer readable medium.

For the first aspect, finally an apparatus is described, which comprises means for receiving at a network element of a network an indication of an active profile for at least one device, the network enabling a communication between different devices; and means for using the indication of the active profile as a criterion for an operation in the network element.

The first aspect proceeds from the consideration that the utilization of information about an active profile of a device does not have to be limited to the internal functionality of the device. Instead, it could be utilized as well for the functionality of a network. To this end, an indication of an active profile of the device could be used in the network as a criterion for an operation in the network element.

The first aspect thus enables the functions and services provided by a network to take different usage profiles into account. The functions and services may relate in particular to a communication between devices via the network.

The first aspect could be implemented for example in an architecture defined by the Open Mobile Alliance™ (OMA), which aims at providing interoperable service enablers working across countries, operators and mobile terminals.

The OMA document “Converged IP Messaging Requirements”, Draft Version 1.0—8 Feb. 2007, Open Mobile Alliance, document code OMA-RD-CPM-V1_{—}0-20070208-D, for example, specifies the following High-Level Functional Requirement: “The CPM user SHALL be able to store user preferences in multiple profiles and indicate one as an active profile. The profiles may be set for different scenario, such as Home, Office, Travel, Sleep, Meeting etc.” The invention could thus be implemented for example in an OMA CPM architecture for supplementing the indicated requirement.

It is to be understood, however, that it may be implemented as well in any other architecture which could benefit from an exploitation of an active profile indication in a network.

In general, the indication of the active profile could be used for example as a condition for at least one rule that is to be applied to a communication request to the at least one device. Such rules could be used for deciding on a variety of possible actions. It is to be understood that predefined rules may be stored at another entity than the entity applying the rules.

The indication of the active profile could be used for example as a condition for an access control for a communication request to the at least one device.

The indication of the active profile could further be used as a condition for at least one request filtering action that is applied to a communication request to the at least one device. The filtering could ensure for example that only communication requests from selected devices are to be accepted, while requests from other devices are rejected, whenever a specific usage profile has been activated.

The indication of the active profile could further be used as a criterion for deciding whether to transform a format of communication data that is to be delivered to the at least one device. The expression communication data is to be understood in this context to be either communication signaling data or communication content data. For example, a ringing tone could be transformed into a text notification, or a voice message could be transformed into a text message.

The indication of the active profile could further be used as a criterion for deciding when and/or how to deliver stored communication data to the at least one device. Stored offline communication could be transferred for example as deferred messages to a device as soon as a predefined usage profile is activated.

A user may have several devices available for communications. In such a case, the indication of the active profile could be used as a criterion for deciding upon a communication request which one of a plurality of devices is to be used in a communication, for example the device which the user currently prefers to use. Conventional solutions are proprietary solutions per device and so they cannot be used for several devices.

The respective apparatus of the first aspect could comprise in addition various other components, like an interface. Further, it could be a complete device or a component for a device. It could be for example an OMA policy extensible markup language document management server, a component for such a server or a device comprising such a server. It could further be for example an OMA converged internet protocol messaging capability center, a component for such a center or a device comprising such a center. It could further be for example an OMA message and media storage entity, a component for such an entity or a device comprising such an entity.

For a second aspect of the invention, a method is described which comprises using at a device a selected active profile as a criterion for determining presence information content, the presence information content indicating the availability of a user of the device for a communication with other devices via a network. The method further comprises causing a transmission of the presence information to the network.

For the second aspect, moreover an apparatus is described, which comprises a processing component configured to use a selected active profile as a criterion for determining presence information, the presence information indicating the availability of a user of a device for a communication with other devices via a network. The apparatus further comprises a processing component configured to cause a transmission of the presence information to the network. Both processing components can be the same processing component or separate processing components.

For the second aspect, moreover a device is described, which comprises the apparatus of the second aspect and an interface configured to enable the transmission of the presence information to the network.

For the second aspect, moreover a computer program product is described, in which program code is stored in a computer readable medium. The computer program code realizes the method of the second aspect when executed by a processor. The computer program product could be again for example a separate memory device, or a memory that is to be integrated in an electronic device.

The invention is to be understood to cover such a computer program code also independently from a computer program product and a computer readable medium.

For the second aspect, finally an apparatus is described, which comprises means for using a selected active profile as a criterion for determining presence information, the presence information indicating the availability of a user of a device for a communication the network enabling a communication between different devices; and means for transmitting the presence information to a network.

Presence information may be understood as a status indicator that expresses an ability and/or willingness of a potential communication partner, for instance a user of a computer or telecommunications network, to communicate. Using presence information is a growing tool towards more effective and efficient communication within a business setting, since it allows to instantly see who is for instance available in a corporate network for a short-term meeting or a conference call.

OMA has specified a presence enabler in “Presence SIMPLE Specification, OMA-ERP-Presence_SIMPLE-V1_{—}0”, including “Presence SIMPLE Architecture Document”, Approved Version 1.0.1—28 Nov. 2006, Open Mobile Alliance, document code OMA-AD-Presence_SIMPLE-V1_{—}0_{—}1-20061128-A. According to this specification, presence information is provided by presence sources, for instance specific agents in a user's client, to a presence service. In this context, a so-called presentity (a combination of the words “presence” and “entity”) is understood as an entity that has presence information associated with it, wherein said presence information may be composed of a multitude of presence sources. A presentity may for instance be a person, although it might also represent a “help desk”, or a resource such as a meeting room, to give but a few examples. A presence server accepts, stores and distributes presence information. A watcher is understood as an entity that requests presence information about a presentity from the presence service. A watcher may for instance be a person that wants to communicate with another person (the presentity) and thus requires presence information on this presentity.

According to the second aspect of the invention, the presence status of a device reflects the selected usage profile. Currently, a user has to remember updating the presence information. If the presence information is automatically updated based on profile selection as described, the presence information will always be up to date and reflect the user's real capabilities to communicate.

An active profile indication indicating the selected usage profile could be transmitted to the network for example together with the presence information or in parallel to the presence information to some other network entity. The active profile indication could be stored for instance either as a part of user profile or presence information.

Also the second aspect could be employed for example in an architecture defined by OMA. It is to be understood again, however, that it may be implemented in any architecture in which a user of a device is enabled to select a usage profile as an active profile and in which the device may publish presence information.

It has to be noted that the features of all presented aspects and exemplary embodiments may also be used in any suitable combination.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not drawn to scale and that they are merely intended to conceptually illustrate the structures and procedures described herein.

### BRIEF DESCRIPTION OF THE FIGURES

FIG. 1 illustrates a possible XDM architecture;

FIG. 2 illustrates a possible CPM architecture;

FIG. 3 is a schematic diagram depicting architectural entities involved in a first embodiment of the invention and their interaction;

FIG. 4 is a schematic diagram depicting architectural entities involved in a second embodiment of the invention and their interaction; and

FIG. 5 is a diagram schematically illustrating a handling of a communication request making use of an embodiment of the invention.

### DETAILED DESCRIPTION OF THE INVENTION

The exemplary embodiments of the invention described in the following enable an enhanced usage of an active profile selection. By way of example, the embodiments are used more specifically for enhancing applicative protocols specified by OMA. The actual implementation will therefore be described after a short introduction to selected OMA architectures. It is to be understood, however, that the invention can be used in any system in which a user of a device is able to access a network and to select one of different usage profiles as an active profile.

OMA has defined a generic framework for Extensible Markup Language (XML) Document Management (XDM) which defines a common mechanism that makes user-specific service-related information accessible to service enablers that need them (cf. document “XML Document Management Architecture”, Candidate Version 2.0—24 Jul. 2007, Open Mobile Alliance, document code OMA-AD-XDM-V2_{—}0-20070724-C, from OMA specification “XML Document Management (XDM) specifications, OMA-ERP-XDM-V2_{—}0 (work in progress)”). Such information is expected to be stored in a network where it can be located, accessed and manipulated (created, changed, deleted, etc.). XDM specifies how such information is defined in well-structured XML documents, as well as the common protocol for access and manipulation of such XML documents. The XML Configuration Access Protocol (XCAP), as defined by the Internet Engineering Task Force (IETF) (cf. “The Extensible Markup Language (XML) Configuration Access Protocol (XCAP)”, Rosenberg, J., May 2007, document code RFC4825), has been chosen as the common XML Document Management protocol.

Documents accessed and manipulated via XCAP are stored in logical repositories in the network, called XML Document Management Servers (XDMS). Each repository may be associated with a functional entity which uses its data to perform its functions. Access and manipulation of the documents may for instance be requested by an XDM client.

The XDM 2.0 architecture introduces a new network element called Shared Policy XDMS, which includes a reusable user access policy document for several enabler (i.e. Push-to-Talk over Cellular (PoC) and Instant Messaging (IM)) based on PoC 1.0 User Access Policy Document that was stored in PoC XDMS (cf. document “PoC XDM Specification”, Approved Version 1.0.1—28 Nov. 2006, Open Mobile Alliance, document code OMA-TS-PoC_XDM-V1_{—}0_{—}1-20061128-A). In this new Shared User Access Policy Document user can store policies where communication from certain user(s)/group(s) can be accepted/rejected based on several criteria e.g. used media type. One example of this kind of policy is that user can reject all group advertisement messages from all others, except persons that are included to his Uniform Resource Identifier (URI) list called friends.

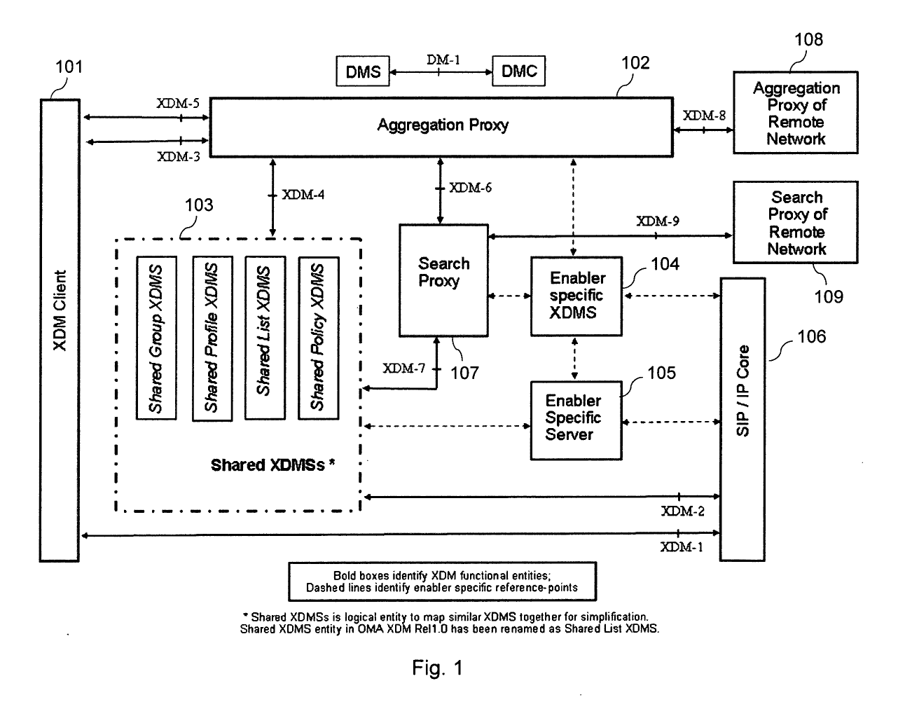

FIG. 1 is a block diagram of an XDM architecture similar to the one presented in the above mentioned document “XML Document Management Architecture”. The system comprises an XDM client 101, an aggregation proxy 102, shared XDMSs 103, an enabler-specific XDMS 104, an enabler-specific server 105, a Session Initiation Protocol (SIP)/IP core 106 and a search proxy 107. In addition, an aggregation proxy of a remote network 108 and a search proxy of a remote network 109 are depicted.

An XDM client 101 provides access to features of shared XDMSs 103 and enabler-specific XDMS 104. The features may include enabling entities to store and manipulate their service-related data stored in a network as XML documents, enabling a subscription/notification mechanism by which entities can be notified of changes to such documents and enabling a mechanism by which entities can search service-related data stored in a network as XML documents. The entities can be for example users or service enablers/applications. An XDM client 101 may be implemented in a terminal or in a server entity.

Aggregation proxy 102 serves as a contact point for XDM client 101 to access and manipulate XML documents stored in XDMSs 103 and/or 104. It may for instance authenticate XDM client 101, and perform routing of XCAP requests to the correct XDMS or to the aggregation proxy of remote network 108. In addition, it may route search requests to the search proxy 107.

Shared XDMSs 103 may contain multiple XDM servers, which can be used by different service enablers. The multiple XDM servers can be of the types shared group XDMS, shared profile XDMS, shared list XDMS and shared policy XDMS. Enabler-specific XDMS 104 manages XML documents of a specific service enabler, such as for instance a CPM enabler, which will be discussed in more detail below. All XDMSs 103 and 104 support manipulation of XML documents stored at the respective XDMS and support SIP subscription/notification, allowing XDM client 101 to subscribe to notification of changes to an XML document in an XDMS. The shared profile XDMS of the shared XDMSs 103 and the enabler-specific XDMS 104 may provide in addition search results, if applicable. XDMSs 103 and 104 may for instance be implemented in software that is executed by a processor, wherein the software may be stored on a fixedly installed or removable computer-readable medium.

The search proxy 107 routes search requests to the concerned XMDS and to search proxies of remote networks 109 and combines obtained search results before sending the result to the requesting client.

Similarly as the enabler specific XDMS 104, enabler-specific server 105 is related to a specific service enabler, such as for instance a CPM enabler. The enabler-specific server 105 may use XDM servers in a similar way as XDM clients do.

SIP/IP core 106 represents a network of servers, e.g. proxies and/or registrars that support certain functions of the XDM service. In particular, routing of the SIP signaling between the XDM client 101 and the XDMSs 103 and 104 is performed by SIP/IP core 106.

FIG. 1 further illustrates various reference points. Reference point XDM-1 provides subscription to and notification of modifications of any XML documents via SIP/IP core 106 using SIP. Reference point XDM-2 provides subscription to and notification of modification of shared XML documents at shared XDMSs 103 via SIP. Reference point XMD-3 provides authentication and XML document management (e.g. document manipulation) via XCAP. Reference point XMD-4 provides shared XML document management (e.g. manipulation) via XCAP. Similar reference points can be defined with respect to enabler-specific XDMS 104, for instance a reference point for subscription to and notification of modifications of XML documents at XDMS 104 via SIP between SIP/IP core 106 and enabler-specific XDMS 104, and a reference point for XML document management (e.g. manipulation) via XCAP between the aggregation proxy 102 and enabler-specific XDMS 104. Reference point XDM-5 between the XDM Client 101 and the Aggregation Proxy 102 provides the function of searching information from XML documents stored in any XDMS. Reference point XDM-6 between the Aggregation Proxy 102 and the Search Proxy 107 provides searching information from XML documents stored in any XDMS. Reference point XDM-7 between the Search Proxy 107 and the Shared XDMSs 103 provides the function of searching information from XML documents that is stored in either the Shared Group XDMS or the Shared Profile XDMS of the shared XDMSs 103. Reference point XDM-9 between the Search Proxy 107 and the Search Proxy 109 of the Remote Network provides the function of forwarding search requests/responses between the Search Proxy and the Remote Network.

For further details, reference is made to the above cited document “XML Document Management Architecture”, which is incorporated by reference herein.

A similar architecture specifically for the OMA Presence enabler can be found in above cited “Presence SIMPLE Architecture Document”, which is incorporated by reference herein.

OMA has defined in addition Converged IP Messaging (CPM) in document “Converged IP Messaging Architecture”, Open Mobile Alliance, Draft Version 1.0, 20 Mar. 2007, document code OMA-AD-CPM-V1_{—}0-20070320-D. CPM is a messaging framework which accommodates different user experiences such as deferred and immediate messaging, session-based messaging, and half duplex/full duplex conferencing. It aims at consolidating common functionalities of existing messaging services and new features introduced by the convergence of communications brought by SIP-based technologies. It interacts with other OMA enablers such as Presence and XDM.

Considering today's diverse user experiences in various service domains, the CPM enabler aims to provide a consistent user experience across many service domains for all IP networks (mobile, home, Internet worlds) by addressing the service constraints in a bearer-agnostic manner. Another feature is the interoperability between different service providers (including roaming conditions).

CPM is targeted to provide a converged messaging capability focusing on the user experiences provided with the following services: Text messaging enabled services (e.g. Short Message Service (SMS), Instant Messaging and Presence Service (IMPS), SIMPLE Instant Messaging (IM), Email, Multimedia Messaging Service (MMS)), Voice-enabled services (e.g. PoC, Voice-over-IP (VoIP)) and Video-enabled service (e.g. Video-o-IP).

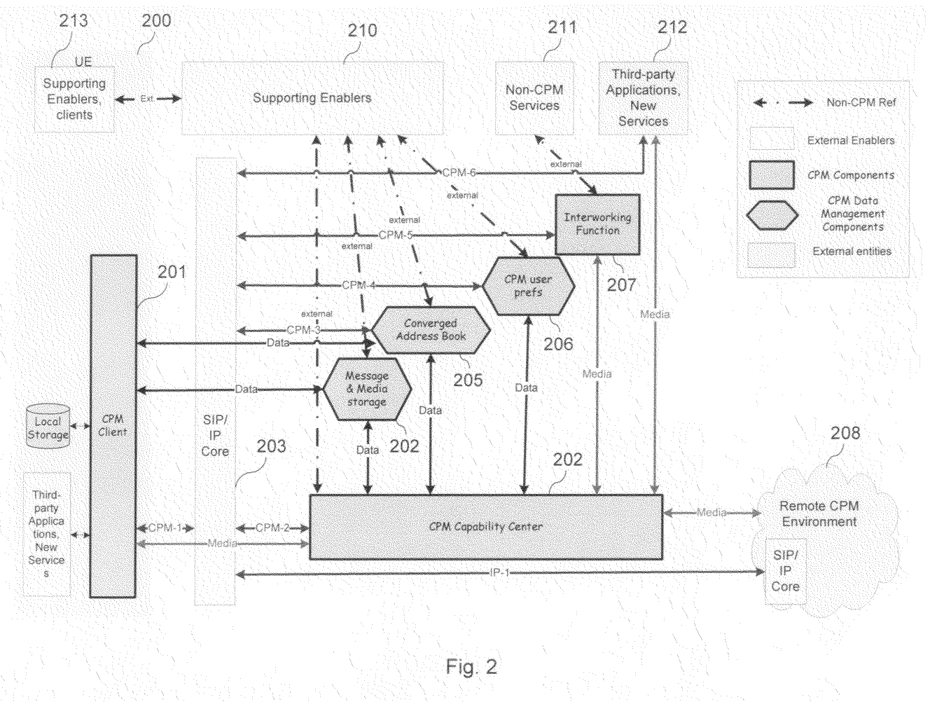

FIG. 2 is a diagram of a CPM architecture similar to the one presented in above cited document “Converged IP Messaging Architecture”.

CPM client 201, which may for instance be comprised in user equipment (UE) 200, allows a user to interact with other CPM components, such as for instance a CPM capability center 202, which performs the main logic and control of the CPM architecture. The CPM capability center 202 provides the CPM service based on services from other CPM components and also from external entities, such as for instance a remote CPM environment 208.

A message & media storage entity 204 includes both management and storage functionalities and can be accessed directly and indirectly by CPM client 201 and CPM capability center 202. A converged address book entity 205 handles and synchronizes the user's address book, which may be relevant in case of the user owning several devices. A CPM user preferences entity 206 supports user preferences relating to the CPM services. Interworking function entity 207 enables communication with external non-CPM services 211, such as for instance the Short Message Service (SMS) or the Multimedia Messaging Service (MMMS). Third party applications 212 use CPM to deliver value added services. Supporting enablers 210 are used to support CPM. Examples of such supporting enablers are XDM or Presence enablers. The supporting enablers 210 may for instance provide an interface for supporting enablers clients 213 in the UE 200 to manage data stored in the CPM user preferences entity 206.

SIP/IP core 203 allows various kinds of communication via the components of the CPM architecture based on the SIP. For instance, CPM session signaling and message exchange between CPM client 201 and CPM capability center 202 is based on the SIP/IP core 203. Furthermore, it allows subscription to and notification of modifications of XML documents stored in enabler-specific XDMS or shared XDMS.

The CPM architecture of FIG. 2 may reuse basically all components of the XDM architecture of FIG. 1. In addition, there may be new XDMSs for all CPM needed data management components (e.g. the CPM user preferences entity 206, the converged address book entity 205 and the message and media storage entity 204) if they don't fit well inside some already defined XDMS.

The supporting enablers entity 210 may implement among other things the XDM aggregation proxy 102 and the search proxy 107 of FIG. 1 and may contain one or more of the shared XDMSs 103 of FIG. 1. The supporting enablers clients 213 at the UE may implement inter alia XDM client functionality. The CPM user preferences entity 206 may implement an XDMS (either one of the shared XDMSs 103 or the enabler-specific XDMS 104, see FIG. 1). It may be accessed by the supporting enablers clients 213 via an aggregation proxy implemented by the supporting enablers entity 210 using the XCAP. The CPM capability center 202 may implement the enabler-specific server 105 of FIG. 1.

For further details, reference is made to the above cited document “Converged IP Messaging Architecture”, which is incorporated by reference herein.

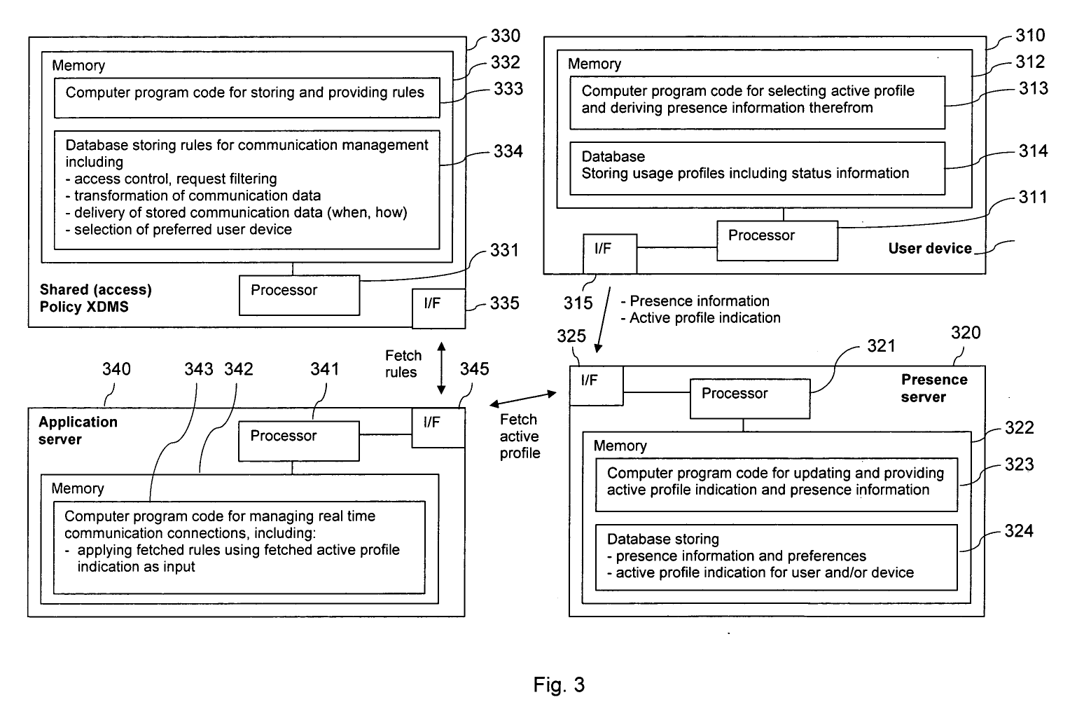

FIG. 3 presents a first exemplary embodiment of the invention.

A system comprises a user device 310, a presence server 320, a Shared Policy XDMS 330 and an application server 340.

The user device 310 can be for example a mobile phone, and it may correspond to the UE 200 of FIG. 2. The user device 310 comprises a processor 311, a memory 312 and an interface 315. The processor 311 is able to execute various computer program codes 313, which may be stored in and retrieved from the memory 312. Executed computer program code may realize among other functions device internal functions and the supporting enablers clients 213 of FIG. 2, which may correspond to an XMD client 101 as described with reference to FIG. 1. Further functions may include a CPM client 201 as described with reference to FIG. 2. The memory 312 may comprise in addition a database 314 for storing a plurality of defined usage profiles. The usage profiles may be predetermined or defined by a user. There may be for example a first usage profile “home” with an associated ring tone 1 and some associated background figure, a second usage profile “office” with an associated ring tone 2 and a third usage profile “meeting” an associated a ring tone 3. Ring tone 3 could be for instance “mute” or “beep”. The interface 315 is configured to enable an exchange of data with other user devices via a network and with elements of the network including the presence server 320.

The presence server 320 may belong for example to one of the supporting enablers 210 of FIG. 2. Further, it could correspond to an enabler-specific server 105 as described with reference to FIG. 1. The presence server 320 comprises as well a processor 321, a memory 322 and an interface 325. The processor 321 is able to execute various computer program codes 323, which may be stored in and retrieved from the memory 322. The memory 322 may comprise in addition a database 324 for storing presence information and active profile indications for a respective user. The interface 325 is configured to enable an exchange of data with the user device 310 and with other network elements including the Shared Policy XDMS 330.

The Shared Policy XDMS 330 may correspond for example to the Shared Policy XDMS of the shared XDMSs 103 of FIG. 1, which may in turn be comprised by the CPM Capability Center 202 of FIG. 2. The shared policy XDMS 330 comprises as well a processor 331, a memory 332 and an interface 335. The processor 331 is able to execute various computer program codes 333, which may be stored in and retrieved from the memory 332. The memory 332 comprises in addition a database 334 storing policy rules for user access policies. The rules can be applied to communication requests. Each rule may define conditions that are to be met, and moreover one or more actions and/or transformations of communication content or signaling data for the case that the defined conditions are met. The executed computer program codes 333 support storing the rules in the database 334 and providing the stored rules to a requesting entity. The interface 335 is configured to enable an exchange of data with other network elements including the application server 340.

The application server 340 may correspond for example to the enabler-specific server 105 of FIG. 1, implemented as a CPM server in the CPM Capability Center 202 of FIG. 2. Alternatively, it may correspond to a PoC Server or an IM Server, etc. The application server 340 comprises as well a processor 341, a memory 342 and an interface 345. The processor 341 is able to execute various computer program codes 343, which may be stored in and retrieved from the memory 342. The executed computer program codes 343 manage real-time communication connections, like voice, video or messaging sessions. The interface 345 is configured to enable an exchange of data with other network elements including the presence server 320 and the Shared Policy XDMS 330.

The entities of FIG. 3 may interact as follows:

The processor 311 executing a computer program code 313 enables a user of device 310 to select one of the defined usage profiles as an active profile. The active profile may be selected specifically for user device 310 or for multiple devices of the user. In the presented situation, the user selected the profile “meeting” as the active profile. Once the user has selected a usage profile to be the active profile, the executed computer program code 313 sets a status parameter of this usage profile in the memory to a value “active”. In addition, the executed computer program code 313 determines presence information content based on the active profile. The presence information content may comprise an indication of the communication types for which a user is currently available and which the user is willing to support. It may be defined, for instance, that the profile “meeting” is associated to a presence for SMS, MMS and email only and that SMS is the preferred type of communication.

The executed computer program code 313 assembles a message including an indication of active profile and presence information including the determined presence information content and causes its transmission via the interface 315 to the presence server.

The presence server 320 receives the assembled message via its own interface 325. The processor 321 executes a computer program code 323 to update the database in memory 322 in accordance with the information in the received message.

In the present situation, for example, the user is indicated in the presence information to be available for SMS, MMS and e-mail only. SMS is set in addition to be the currently preferred communication type and provided with an indication “priority=1”.

Further, a parameter “active profile” is set to “meeting”. In case the active profile is to be valid for multiple devices of the user of device 310, the parameter “active profile” may be set to “meeting” for instance in a <person> main element of the database. In case the active profile is to be valid specifically for device 310, the parameter “active profile” may be set to “meeting” for instance in a <device> main element of the database. The active profile parameter for other devices of the user may then be kept at another value, for example “home”, in an associated <device> entry of the database.

When another device requests a communication with user device 310, this request is processed by an application server 340 that is responsible for the requested type of communication. The executed program codes 343 of the application server 340 decides what to do with a communication request by applying predefined policy rules. These rules are fetched by executed program codes 343 from Shared Policy XDMS 330. The rules use the active profile indication of the device 310 to which the communication request is directed as one selection criterion. To be able to apply the rules, the application server 340 therefore fetches in addition the active profile indication from the presence server 320 for evaluating the predefined ruled. Fetching the policy rules from Shared Policy XDMS 330 is supported by executed computer program codes 333 and fetching the active profile indication from the presence server 320 is supported by executed computer program codes 323. In the present situation, the fetched active profile indication indicates the profile “meeting” to be active.

With an active profile “meeting”, for example a first rule may apply. This rule may be defined to be used under the condition that an active profile of an addressed party is “meeting”, that the request is from a “friend” registered as such in the URI list of the addressed party and that the request type is “voice”. If these conditions are met, applied actions may comprise accepting the request and applied transformations may comprise formatting the call to a voice mail. Other rules for the condition that an active profile of an addressed party is “meeting” may be defined for instance for other requesting entities than friends and/or for other communication types than voice.

Further rules are applicable in the case of other active profiles than “meeting”. They might comprise for example a rule, which is to be used under the condition that an active profile of an addressed party is “home”. If this condition is met, applied actions may comprise accepting the request and applied transformations may comprise directing the request to a user device of the addressed party which is to be used when the active profile is “home”.

Additional rules may be defined accordingly for other condition constellations.

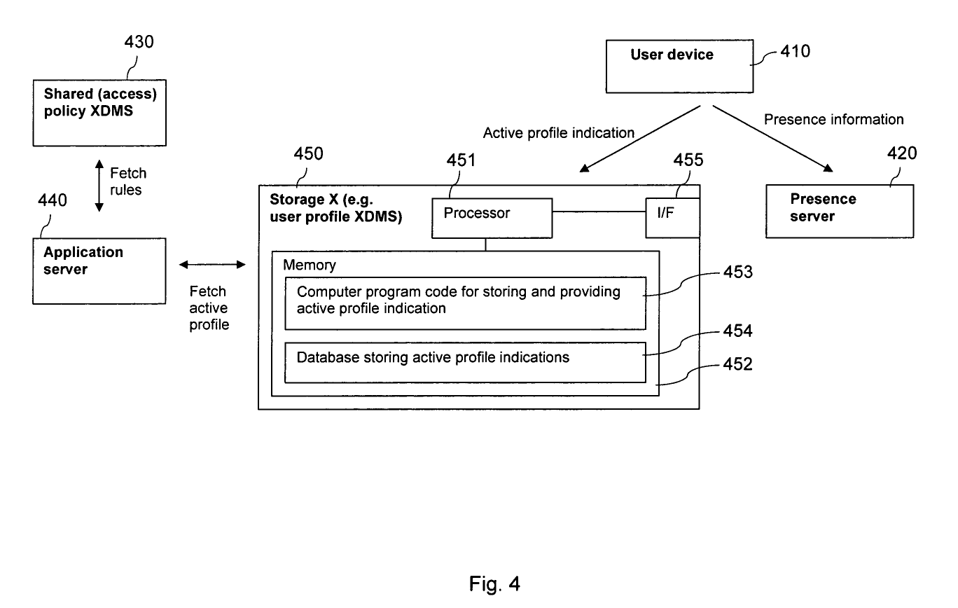

FIG. 4 presents a second exemplary embodiment of the invention.

A system comprises again a user device 410, a presence server 420, a shared policy XDMS 430 and an application server 440, which may be similar to user device 310, presence server 320, shared policy XDMS 330 and application server 340, respectively, of FIG. 3.

In this case, however, the system comprises in addition a storage entity 450.

The storage entity 450 may correspond for example to the shared profile XDMS of shared XDMSs 103 or to an enabler specific XDMS 104 described with reference to FIG. 1. In the system of FIG. 2, the storage entity 450 could be comprised by the supporting enablers entity 210 or correspond to the CPM user preferences entity 206.

The storage entity 450 comprises a processor 451, a memory 452 and an interface 455. The processor 451 is able to execute various computer program codes 453, which may be stored in and retrieved from the memory 452. The memory 452 may comprise in addition a database 454 for storing active profile indications. In case a user has several devices, the active profile indication may be associated in common to all devices of a user or separately to each device of a user. The interface 455 is configured to enable an exchange of data with user devices including the user device 410 and with other network elements including the application server 440.

The entities of FIG. 4 may interact as follows:

As described with reference to FIG. 3 for user device 310, also the user device 410 enables a user to select one of the defined usage profiles as the active profile. In an exemplary situation, the user is assumed again to select the profile “meeting” as the active profile. A status parameter of this profile is set to a value “active”. In addition, the user device 410 derives presence information content based on the selected active profile.

In this case, however, the user device 410 transmits only presence information including the determined presence information content to the presence server 420 for a publication of the presence information. In addition, it transmits an active profile indication to the storage entity 450.

The presence server 420 receives the presence information and updates the database accordingly. Active profile indications are not stored in the database of the presence server 420 in this case.

The storage entity 450 receives the active profile indication via its interface 455. The processor executes computer program codes 453 to update the database in memory 452 in accordance with the received active profile indication. In the present example, a parameter “active profile” is set to “meeting”. Such a parameter may be set for the user of device 410 and be valid for all devices of this user. Alternatively, such a parameter may be set specifically for device 410, while the active profile parameter for other devices of the user may be kept at another value, for instance “home”.

When another device requests communicating with user device 410, this request is processed by an appropriate application server 440 in accordance with predefined rules which use an active provide indication as a selection criterion. When receiving a communication request, the application server 440 therefore first fetches the policy rules from the shared policy XDMS 430 and the active profile indication for user device 410 from the storage entity 450 for being able to select an appropriate one of the predefined ruled, and then applies the associated actions and transformations.

In both FIGS. 3 and 4, SIP may be used to establish a communication (voice, video, messaging etc.), while XCAP may be used to handle data stored at the data storage servers.

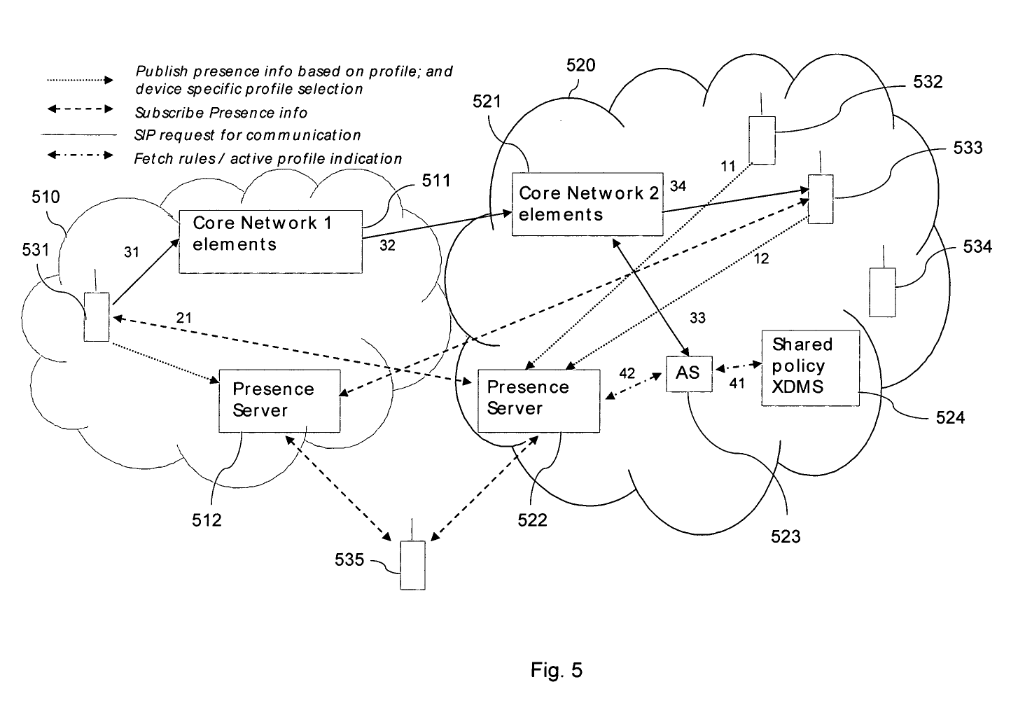

FIG. 5 is a diagram illustrating an example of incoming request handling by a network entity in accordance with an embodiment of the invention.

FIG. 5 presents a system comprising different networks 510, 520 that are operated by different network operators and that provide an access to mobile devices via a radio interface. For two of the networks, the core network elements are summarized in a respective block 511, 521. Each network comprises in addition a presence server (PS) 512, 522. For network 520, in addition a SIP application server (AS) 523 and a Shared Policy XDMS 524 are shown. The application server 523 may support a multimedia communication and belong to an Internet Protocol (IP) multimedia subsystem (IMS).

Several mobile devices are attached to the networks. Mobile device 531 is attached to network 510, mobile devices 532, 533 and 534 are attached to network 520, and mobile device 535 is attached to a further network not shown. Mobile devices 532 and 533 could belong for example to the same user.

Each device 531-535 publishes its presence information. The information is conveyed to the presence server of the home network of the device. This is indicated in FIG. 5 with dotted arrows. For example, the presence information published by mobile devices 532 and 533 is provided to presence server 522 (dotted arrows 11 and 12, respectively). The received presence information is stored in the presence server 512, 522. The content of the presence information may be determined by a device based on a selected active profile, as described for user device 310 with reference to FIG. 3. As a result, the user (=presentity) of the device 531-535 does not need to remember to keep presence information up-to-date, since the presence publication can be triggered automatically upon the active profile selection.

An active profile indication determined by the mobile devices 531-535 may be published together with the presence information and provided to the presence servers 512, 522. The presence servers 512, 522 may then store the received active profile indication as well, for example as described for presence server 320 with reference to FIG. 3. The active profile indication could be used in the Presence server for a combined setting regarding multiple devices of the user (e.g. as a part of a <person> main element), for a device specific setting (e.g. as a part of a <device> main element) or for both combined and device specific settings. Since there can be different active profiles selected in different devices of a user, the combined setting may be set based on user's decision. Alternatively, only one of the devices could be allowed to publish that information.

Alternatively, a device 531-535 could publish only presence information for storage by a presence server, and provide the active profile indication for storage to some other network element, for instance as Shared Profile information to a shared user profile XDMS as described with reference to FIG. 4. Further alternatively, it would be possible that a device provides only the active profile indication for storage. This last alternative may depend in particular on the device implementation and/or on the user's desire not to publish any presence information.

Each mobile device 531-535 may further subscribe to the presence information of other users or devices to see the presence of the users. They are notified with each change in the presence information of another device for which a subscription is established. In FIG. 5, the subscription is indicated with dashed arrows between the devices 531-535 and the presence servers 512, 522. For example, mobile device 531 may subscribe to the presence information of mobile device 533 with presence server 522 (dashed arrow 21).

Requests for communications in the system of FIG. 5 make use of SIP messages, which are indicated in FIG. 5 with solid lines.

When mobile device 531 is notified by presence server 522 about the presence of device 532 of a particular user for a particular type of communication and desires to get into contact with the user of device 532, it sends a SIP request for communication to the network 510 (solid arrow 31). The request is routed by the core network elements 511 of network 510 to the core network elements 521 of network 520 (solid arrow 32).

The core network elements 521 contact the application server 523 (solid arrow 33). The application server 523 comprises an application which is responsible in network 520 for managing real-time communication connections based on defined user access policies. The application server 523 may correspond to the application server 340 of FIG. 3.

The application server 523 fetches the policy rules from the Shared policy XDMS 524 (dot-and-dash arrow 41) and the active profile indication for mobile device 532 from the presence server 522 (dot-and-dash arrow 42), for example to be able to decide how to handle the incoming request. The Shared Policy XDMS 524 may correspond to Shared Policy XDMS 330 of FIG. 3.

If the active profile is a “meeting” or “silent” profile, for instance, the application server 523 might be required according to the implemented rules to forward the request to another address or storage, like a voice mail or message storage. Alternatively, the application server 523 might also be required to reject the request by sending a pre-defined response to the originating device 531 based on the indicated active profile and the originator's identity. Further alternatively, the application server 523 might also be required to adjust content based on the indicated active profile, for example by delivering only a text based notification to mobile device 532.

FIG. 5 presents a further possible handling that might be required. With the currently active profile for mobile device 532, the application server 523 is required by way of example to direct a communication request to device 532 to an appropriate device of a user's multiple devices 532, 533 by evaluating the device specific active profile selections. In the presented case, the application server 523 causes the core network elements 521 to route the request to mobile device 533 instead of to mobile device 532.

In a similar way, the Message & Media Storage entity 202 of FIG. 2 could utilize the active profile information. The Message & Media Storage entity 202 could use the active profile information for example as a part of user preference information to decide whether, when and how to send notifications related to stored items to the device of a user. Further, the Message & Media Storage entity 202 could use the active profile information for example to decide whether a notification should be sent only to certain devices.

Equally, any other data storage with data manipulation capabilities could utilize the active profile information.

The presented embodiments allow leaving the device profile information and its structure undefined as such. Therefore, it is possible to use the current proprietary device profile solutions, and enhance them with the capabilities to just publish or store the active profile information. Moreover, since both the user preference type of information and publication/storing of active profile information are set by the user (or the user's devices on behalf of the user), the indication matches with the preference settings, and there is no need to define for example a fixed set of available profiles. Thus, the presented embodiments are also compatible with implementations in which a user can freely create new profiles.

The functions illustrated by the processor 341 executing program codes 343 from memory 342 can also be viewed as means for receiving at a network element of a network an indication of an active profile for at least one device, the network enabling a communication between different devices; and as means for using the indication of the active profile as a criterion for an operation in the network element. The program codes 343 stored in memory 342 can also be viewed as comprising such means in the form of functional modules.

The functions illustrated by the processor 311 executing program codes 313 from memory 312 can also be viewed as means for using at a device a selected active profile as a criterion for determining presence information content, the presence information content indicating the availability of a user of the device for a communication with other devices via a network; and for causing a transmission of the presence information to the network. The program codes 313 stored in memory 312 can also be viewed as comprising such means in the form of functional modules.

While there have been shown and described and pointed out fundamental novel features of the invention as applied to preferred embodiments thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto. Furthermore, in the claims means-plus-function clauses are intended to cover the structures described herein as performing the recited function and not only structural equivalents, but also equivalent structures.

What is claimed is:

1. A method comprising:
receiving at a network element of a network an indication of an active profile for at least one device, the network enabling a communication between different devices; and
using the indication of the active profile as a criterion for an operation in the network element.

2. The method according to claim 1, wherein using the indication of the active profile as a criterion for an operation in the network element comprises using the indication of the active profile as a condition for at least one rule that is to be applied to a communication request to the at least one device.

3. The method according to claim 1, wherein using the indication of the active profile as a criterion for an operation in the network element comprises using the indication of the active profile as a condition for an access control for a communication request to the at least one device.

4. The method according to claim 1, wherein using the indication of the active profile as a criterion for an operation in the network element comprises using the indication of the active profile as a condition for at least one request filtering action that is applied to a communication request to the at least one device.

5. The method according to claim 1, wherein using the indication of the active profile as a criterion for an operation in the network element comprises using the indication of the active profile as a criterion for deciding whether to transform a format of communication data that is to be delivered to the at least one device.

6. The method according to claim 1, wherein using the indication of the active profile as a criterion for an operation in the network element comprises using the indication of the active profile as a criterion for deciding when to deliver stored communication data to the at least one device.

7. The method according to claim 1, wherein using the indication of the active profile as a criterion for an operation in the network element comprises using the indication of the active profile as a criterion for deciding how to deliver stored communication data to the at least one device.

8. The method according to claim 1, wherein using the indication of the active profile as a criterion for an operation in the network element comprises using the indication of the active profile as a criterion for deciding upon a communication request which one of a plurality of devices is to be used in a communication.

9. An apparatus comprising:
a processing component configured to receive an indication of an active profile for at least one device and configured to use the indication of the active profile as a criterion for an operation in the apparatus;
wherein the apparatus belongs to a network enabling a communication between different devices.

10. The apparatus according to claim 9, wherein the processing component is configured to use the indication of the active profile as a condition for at least one rule that is to be applied to a communication request to the at least one device.

11. The apparatus according to claim 9, wherein the processing component is configured to use the indication of the active profile as a condition for an access control for a communication request to the at least one device.

12. The apparatus according to claim 9, wherein the processing component is configured to use the indication of the active profile as a condition for at least one request filtering action that is applied to a communication request to the at least one device.

13. The apparatus according to claim 9, wherein the processing component is configured to use the indication of the active profile as a criterion for deciding whether to transform a format of communication data that is to be delivered to the at least one device.

14. The apparatus according to claim 9, wherein the processing component is configured to use the indication of the active profile as a criterion for deciding when to deliver stored communication data to the at least one device.

15. The apparatus according to claim 9, wherein the processing component is configured to use the indication of the active profile as a criterion for deciding how to deliver stored communication data to the at least one device.

16. The apparatus according to claim 9, wherein the processing component is configured to use the indication of the active profile as a criterion for deciding upon a communication request which one of a plurality of devices is to be used in a communication.

17. The apparatus according to claim 9, wherein the apparatus is one of:
an open mobile alliance policy extensible markup language document management server;
an open mobile alliance converged internet protocol messaging capability center;
an open mobile alliance message and media storage entity;
a component for an open mobile alliance policy extensible markup language document management server;
a component for an open mobile alliance converged internet protocol messaging capability center; or
a component for an open mobile alliance message and media storage entity.

18. A system comprising:
an apparatus according to claim 9; and
an apparatus belonging to the network and including a storage configured to store an indication of an active profile for at least one device.

19. A system comprising:
an apparatus according to claim 9; and
at least one device configured to provide an indication of an active profile for the at least one device to the network.

20. A computer program product in which program code is stored in a computer readable medium, the computer program code realizing the method of claim 1 when executed by a processor.

21. An apparatus comprising:
means for receiving at a network element of a network an indication of an active profile for at least one device, the network enabling a communication between different devices; and
means for using the indication of the active profile as a criterion for an operation in the network element.

22. A method comprising:
using at a device a selected active profile as a criterion for determining presence information content, the presence information content indicating the availability of a user of the device for a communication with other devices via a network; and
causing a transmission of the presence information to the network.

23. An apparatus comprising:
a processing component configured to use a selected active profile as a criterion for determining presence information, the presence information indicating the availability of a user of a device for a communication with other devices via a network; and
a processing component configured to cause a transmission of the presence information to the network.

24. A device comprising the apparatus according to claim 23 and an interface configured to enable the transmission of the presence information to the network.

25. A computer program product in which program code is stored in a computer readable medium, the computer program code realizing the method of claim 22 when executed by a processor.
